(19) United States
(12) Patent Application Publication
(10) Pub. No.: US 2003/0083945 A1
(43) Pub. Date: May 1, 2003

(54) Transaction authorization method, system and device

(76) Inventors: Kee Hooi Jimmy NG, Singapore (SG); Narayanaswamy Perumalswamy Srinivasan Venkatesh, Singapore (SG)

Correspondence Address: HEWLETT-PACKARD COMPANY, Intellectual Property Administration, P. O. Box 272400, Fort Collins, CO, 80527-2400, US

(21) Appl. No.: 10/045,418

(22) Filed: Oct. 26, 2001

(51) Int. Cl. G06F 17/60; G07G 1/00

(52) U.S. Cl. 705/21; 235/7 R

(57) ABSTRACT

A method in a transaction system for authorizing a commercial transaction is disclosed. The method includes receiving transaction-related information that includes an identifier of an account. The identifier is used to access information associated with the account in the transaction system. Verification steps are performed on the information and an approval signal is generated upon satisfactory verifications. The method further includes initiating connection with a communication device associated with the account. The transaction system requests a transaction confirmation from the communication device over the connection. The transaction system authorizes the commercial transaction on receiving the approval signal and the transaction confirmation. A transaction system that performs the above method and a communication device that is able to respond to the request for a transaction confirmation are also disclosed.

### BACKGROUND

This invention relates generally to a transaction authorization method, system and device. More particularly, this invention relates to a relatively more secure transaction authorization method, system and device that require a transaction initiated at a point of sales to be separately confirmed.

In the prior art, a card belonging to a card holder is used to settle a transaction. The card may be a debit card, a credit card or any other suitable card. Upon application and approval, a card issuer sends the card to the card holder. The card typically has a magnetic strip which contains information relating to the card issuer and the card holder. The card also has other information printed on the card, such as the name of the card holder, a card number and an expiration date. The card holder is also typically required to sign to provide an authorized signature that is used for verification purposes during a transaction.

When the card holder wishes to settle a transaction with a merchant in a shop or restaurant, the card is presented to the merchant by the card holder. The merchant swipes the card through a point of sale (POS) device to allow the device to read the information encoded on the card. Usually, the POS device will call up a card acquirer for approval of the transaction. The card acquirer is an entity which provides merchants with the payment associated with transactions. The card acquirer also settles transactions with card issuers. If the card holder is determined not to have exceeded his credit limit and the card is not reported stolen or lost, the card acquirer will usually approve the transaction. The card holder's signature on a transaction slip is also required to verify the card holder's agreement to the transaction.

The verification of a card holder's on-the-spot signature on a transaction slip against the authorized signature on the card is only effective to a limited extent for reducing fraud. An unauthorized person in possession of an original card can forge the authorized signature. Cards can be copied and new signatures can be applied to these copied cards, rendering signature verification useless for detecting fraud. Fraud is also made easier for transactions that do not require the use of a physical card, such as the use of a card to purchase items through the Internet or over the telephone.

Systems have been proposed for making transactions using cards more secure. One such system is disclosed in U.S. Patent Application 2001/0005832. In that system, a communication device is used in place of the card. During a transaction, the communication device is used to communicate separately with a POS device and a financial institution. The communication device acts as a mediator between the POS device and the financial institution. The financial institution stores a virtual card and information of the virtual card is forwarded to the POS device via the communication device to permit a transaction to occur. In such a system, the communication device effectively never leaves the financial institution or is always accessible by the financial institution. The virtual card information includes at least the same information that is contained on an actual card and additionally can contain further information. The communication device authenticates itself to the financial institution when communicating with the financial institution. Security in such a system is an improvement over the prior art because the communication device is relatively more difficult to copy compared to a physical card. Also, the information of the virtual card is under the control of the financial institution and thus is more difficult to be modified or copied.

Although this prior art system improves security, it requires significant modifications to be made to a conventional transaction system. The conventional communication device, such as a mobile phone, and the POS device will have to be significantly modified to allow them to communicate in the manner required by the disclosed system.

### SUMMARY

According to an embodiment of the present invention, there is provided a method in a transaction system for authorizing a commercial transaction. The method includes receiving transaction-related information aincluding an account identifier of an account. The account identifier is used to access information associated with the account. Verification steps are performed on the information and an approval signal is generated depending satisfactory verifications. The method further includes contacting a communication device associated with the account. The transaction system requests a transaction confirmation from the communication device. The transaction system authorizes the commercial transaction on receiving the approval signal and the transaction confirmation.

Further according to the embodiment of the present invention, there is also provided a transaction system that performs the method of authorizing a commercial transaction described above.

Further according to the embodiment of the present invention, there is also provided a communication device for confirming a commercial transaction. The communication device is able to respond to the above-described request for a transaction confirmation.

### BRIEF DESCRIPTION OF DRAWINGS

The invention will be better understood with reference to the drawings, in which:

FIG. 1 is a block diagram of a transaction system according to an embodiment of the present invention; and

FIG. 2 is a flowchart showing a sequence of steps for obtaining an authorization for a commercial transaction in the transaction system in FIG. 1.

### DETAILED DESCRIPTION

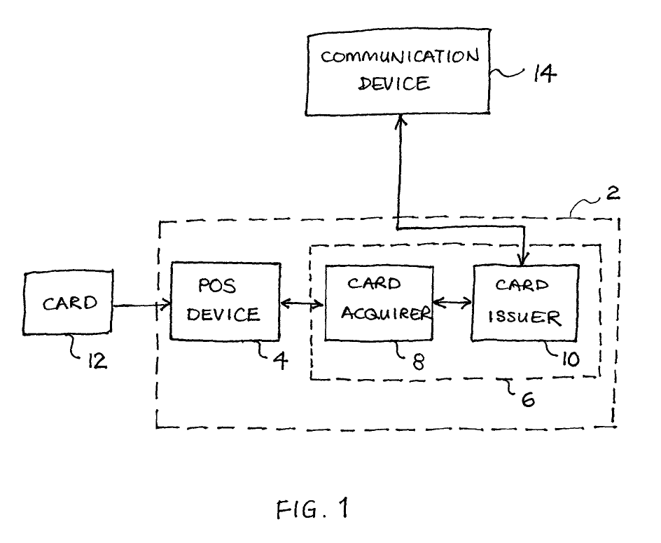

FIG. 1 shows a block diagram of a transaction system 2 according to an embodiment of the present invention. The transaction system 2 includes a point of sale (POS) device 4 and a financial institution, which is hereafter referred to as an authorization center 6. The authorization center 6 typically includes a card acquirer 8 and a card issuer 10. The card acquirer 8 and the card issuer 10 may be separate entities or a single entity, all of which are known to those skilled in the art. In the embodiment, the card issuer 10 preferably issues a physical card 12 to an account owner, which is hereafter referred to as a card holder. The card contains information of a type that is known to those skilled in the art.

When a card holder wishes to pay for goods purchased in, for example a departmental store, the card holder presents the card 12 to a salesperson to begin the purchase transaction. The salesperson swipes the card 12 through the POS device 4, which in this particular embodiment is a card reader. The POS device 4 reads the card to obtain necessary information from the card 12. The POS device 4 sends the information and other information related to the transaction, for example the amount of the purchase and the identity of the merchant (departmental store) preferably to the card acquirer 8 in order to proceed with the transaction.

When the card acquirer 8 receives the information sent by the POS device 4, the card acquirer 8 determines if the transaction is allowed or disallowed by accessing account information of the card holder and making one or more verifications on the account information. Such verifications include checking if the amount of the transaction exceeds a credit limit if the card 12 is a credit card and checking if there are available funds if the card 12 is a debit card. The verifications may also include determining if the transaction exceeds the maximum permitted amount for a single transaction and determining if the transaction type is one which is permitted. The verifications may further include determining if the transaction causes any maximum spending for a predetermined period to be exceeded. Depending on the results of these verifications, the card acquirer 8 will either approve or disapprove the transaction. Details of the transaction are stored in an appropriate transaction log file (not shown).

If the card acquirer 8 does not have the information to perform the verifications, the card acquirer 8 will forward the information it receives from the POS device 4 to the card issuer 10 for the card issuer 10 to perform the necessary verifications. Regardless of whether the card acquirer 8 or the card issuer 10 performs the verifications, the transaction system 2, preferably through the card issuer 10, contacts a communication device 14 associated with the card holder to request a transaction confirmation. The card issuer 10 accesses a data store (not shown) that contains a lookup table to obtain a contact number of the communication device 14. The communication device 14 may for example be a mobile phone. In such a case, the card issuer 10 initiates a connection with the communication device 14 via a public network to request the transaction confirmation by sending a short message using a short message service (SMS), by performing a wireless application protocol (WAP) push operation or by other suitable means. As the communication device 14 may be associated with more than one card 12, the card issuer 10 sends information related to the transaction to the communication device 14 when requesting the transaction confirmation. The information includes the card number, location of transaction, merchant details and an amount of the transaction. Other information, such as a request identity that uniquely identifies the request, may be included.

It should be appreciated that the communication device 14 may also be a dedicated device issued by the card issuer 10 for use in settling a transaction. The communication device 14 may also be any other suitable device, such as a personal digital assistant, a two-way pager or the like. Also it should be noted that the connection between the communication device 14 and the card issuer 10 may take any suitable alternate form, such as a data call, a page, etc. The connection may be a wired connection or a wireless connection using radio frequency or any other suitable means.

The user of the communication device 14 upon being alerted of the receipt of the request on the communication device 14 may respond to the request by sending to the card issuer 10 either a confirmation or a refusal of the transaction. The user of the communication device 14 may or may not be the card holder. The response may be in the form of a message containing information that includes the identity of the request being responded to and a flag indicating whether the response is a confirmation or a refusal. Alternatively, the response may echo information received by the communication device 14 during the request.

Optionally, a password may be included in the response. Such a password allows verification by the card issuer 10 against an authorized password stored in the data store of the card issuer 10 to make the transaction more secure.

After the card issuer 10 receives the response, either party 10, 14 may terminate the connection. In the event that no response is received within a predetermined period after a request is sent, the card issuer 10 may terminate the connection. In such a case, the transaction will be refused.

In another embodiment, a response operation on the communication device 14 may be password protected. In the event that both the communication device 14 and the card 12 are in the possession of an unauthorized person, the password may prevent a response from being sent to complete the transaction.

In yet another embodiment, the communication device 14 may be provided with a first password that is not ordinarily accessible and readable by a user. During the transaction, the card holder is required to enter a second password preferably via the POS device. This card holder entered second password is routed to the communication device 14 along with the request for a transaction confirmation. If the entererd second password is determined by the communication device 14 to match the first password, the communication device 14 will automatically respond to the request by sending a confirmation. If the first and the second passwords do not match, the communication device 14 will respond by refusing the transaction. This particular embodiment frees the card issuer 10 from having to store and match passwords. This embodiment is also advantageous in that it does not require the communication device 14 to be manually operated to respond to the request.

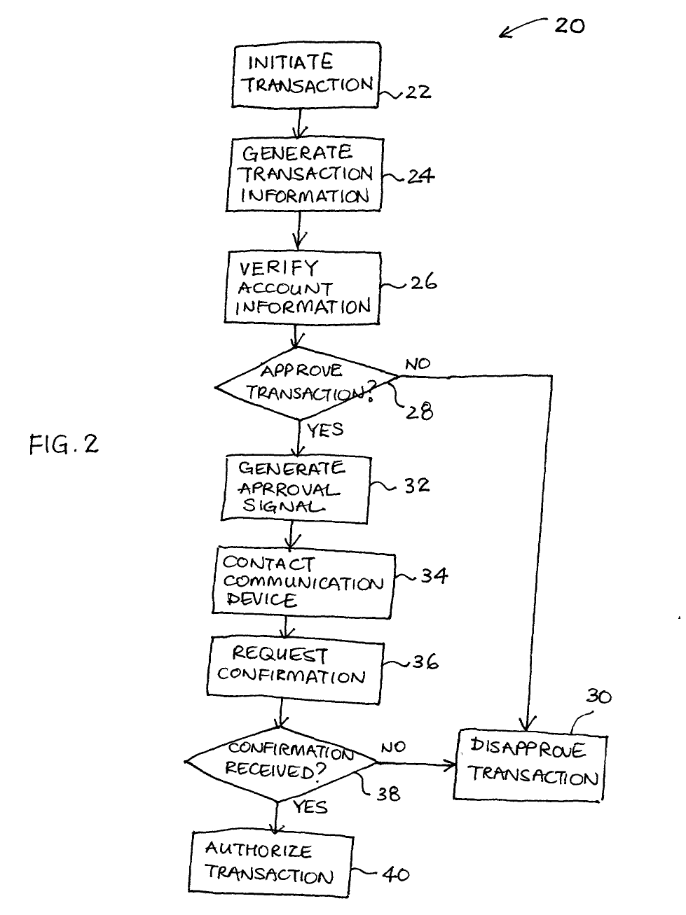

The process that will be carried out in order to complete a commercial transaction will now be described with reference to FIG. 2, which includes a sequence 20 of steps for obtaining authorization for the transaction using the transaction system 2 described above.

The sequence 20 starts in an INITIATE TRANSACTION step 22, wherein the card holder approaches a point of sale to initiate a transaction. The card holder hands the card 12 to a salesperson at the point of sale. In a subsequent GENERATE TRANSACTION INFORMATION step 24, the salesperson swipes the card through the POS device 4 for the POS device 4 to read information on the card 12. The salesperson further generates other information related to the transaction, such as the value or amount of the transaction. The POS device 4 forwards this information together with additional information such as a merchant identifier over a conventional network to the card acquirer 8.

In a subsequent VERIFY ACCOUNT INFORMATION step 26, the card acquirer 8 or the card issuer 10 retrieves account information related to the card 12 and performs the necessary verifications as previously described. The sequence 20 next proceeds to an APPROVE TRANSACTION? step 28, wherein it is determined if the transaction passes the necessary verifications. If it is determined that one or more verifications failed, the sequence 20 proceeds to a DISAPPROVE TRANSACTION step 30, wherein payment using the card is disapproved at the point of sale.

However, if it is determined in the APPROVE TRANSACTION? step 28 that all necessary verifications are passed, the sequence 20 proceeds to a GENERATE APPROVAL SIGNAL step 32, wherein either the card acquirer 8 or the card issuer 10 generates an approval signal for the transaction. The sequence 20 next proceeds to a CONTACT COMMUNICATION DEVICE step 34, wherein the transaction system 2, preferably through the card issuer 10, contacts the communication device 14 that is associated with the card 12 to establish a connection. If the communication device 14 cannot be contacted, the transaction is disapproved. If the communication device 14 can be contacted, the card issuer 10 sends a message to the communication device 14 to request a transaction confirmation in a REQUEST CONFIRMATION step 36. Additionally, the card issuer 10 may authenticate the communication device 14 using any authentication process available in mobile phone systems. The communication device 14 may either automatically respond to the request or be manually operated by a user as previously described to respond to the request. The communication device 14 may optionally request verification data from the user. The verification data may include a password, a PIN or any biometric data such as a finger print. The verification data makes it difficult for an unauthorized user to access the communication device 14 for responding to the request.

The sequence 20 next proceeds to a CONFIRMATION RECEIVED? step 38, wherein the card issuer 10 determines if a transaction confirmation has been received from the communication device 14. If it is determined that a transaction confirmation has not been received, the sequence 20 proceeds to the DISAPPROVE TRANSACTION step 30. However, if it is determined that a transaction confirmation is received, the sequence 20 proceeds to an AUTHORIZE TRANSACTION step 40, wherein the transaction is authorized at the POS device 4. Thereafter, payment may proceed in a conventional manner.

Advantageously, the method and system 2 described in various embodiments provide for more secure transactions. In a simplest embodiment, only the card issuer 10 in the conventional system needs to be modified. Extensive modifications to the entire system are not necessary.

Although the present invention is described in the context of a transaction involving a physical card at a point of sale, the invention should not be construed to be limited as such. The invention may for example be used for payment through the Internet or over the telephone where only information of the card needs to be presented. In such cases, a computer or a telephone which receives the information performs the role of a POS device.

The physical card may also be replaced by any suitable information storage device, such as a personal digital assistant or a mobile phone that can be connected to an appropriate POS device. This connection can be by any suitable means, such as via an infra red connection. Instead of a card number, the information storage device may contain an account identifier instead.

In the department store environment, payment may also be made through a mobile salesperson instead of at a fixed point of sale as described. The mobile salesperson may carry a wireless communication device that can communicate directly with the card acquirer 8 or indirectly with the card acquirer 8 via the POS device 4. The payment scheme in which the communication device communicates directly with the card acquirer 8 is similar to a transaction through the Internet.

Embodiments of the present invention may also be used to support other types of facility such as an electronic purse or cash.

We claim:

1. A method in a transaction system for authorizing a commercial transaction comprising:
receiving transaction-related information, including an account identifier of an account;
accessing and verifying information associated with the account;
generating an approval signal upon satisfactory verification;
contacting a communication device associated with the account;
requesting a transaction confirmation from the communication device; and
authorizing the commercial transaction on receiving the approval signal and the transaction confirmation.

2. A method according to claim 1, wherein contacting a communication device includes contacting a communication device that is verification-data protected for responding to a request for a transaction confirmation.

3. A method according to claim 2, wherein contacting a communication device that is verification-data protected includes contacting a communication device that is password-protected.

4. A method according to claim 2, wherein contacting a communication device that is verification-data protected includes contacting a communication device that is biometric-data protected.

5. A method according to claim 1, wherein requesting a transaction confirmation from the communication device includes receiving a transaction confirmation automatically generated by the communication device.

6. A method according to claim 1, wherein contacting a communication device includes contacting a communication device that supports a first password therein and wherein requesting a transaction confirmation from the communication device includes receiving a transaction confirmation generated by the communication device only if a second password received along with the transaction-related information is sent to the communication device and is verified to match the first password.

7. A method according to claim 1, wherein contacting a communication device includes contacting a communication device associated with the account via a public communication network.

8. A method according to claim 1, wherein contacting a communication device includes contacting a communication device by an authorization center in the transaction system.

9. A method according to claim 8, wherein contacting a communication device includes contacting a communication device by a card issuer of the authorization center.

10. A method according to claim 1, wherein contacting a communication device includes contacting a dedicated communication device issued by the card issuer.

11. A method according to claim 1, wherein contacting a communication device includes contacting one of a mobile phone and a two-way pager via a public network.

12. A transaction system comprising:
a POS device for receiving transaction-related information including an account identifier of an account;
an authorization center for accessing and verifying information associated with the account and for generating an approval signal upon satisfactory verification; and
means for contacting a communication device associated with the account and for requesting a transaction confirmation from the communication device;
wherein the commercial transaction is authorized on receiving the approval signal and the transaction confirmation.

13. A communication device suitable for use for confirming a commercial transaction comprises:
means for establishing a connection initiated by a transaction system;
means for receiving a request for a transaction confirmation; and
means for responding to the request by sending the transaction confirmation.

14. A communication device according to claim 13, further including means for requesting verification data from a user of the communication device before responding to the request.

15. A communication device according to claim 13, further including means for storing a predetermined first password.

16. A communication device according to claim 15, wherein the means for receiving a request for a transaction confirmation includes means for receiving a second password along with the request for a transaction confirmation and wherein the means for responding to the request by sending the transaction confirmation includes means for responding to the request only when the second password is verified to match the first password.
